(19) United States
(12) Patent Application Publication
(10) Pub. No.: US 2007/0099569 A1
(43) Pub. Date: May 3, 2007

(54) Method and apparatus for terminating undesired communications

(75) Inventors: Brian K. Smith, Wellington, FL (US); Brian L. Grinage, Wellington, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/263,161

(22) Filed: Oct. 31, 2005

(51) Int. Cl. H04B 1/00

(52) U.S. Cl. 455/63.1; 455/67.11; 455/73

(57) ABSTRACT

An apparatus and method (200) are disclosed for terminating undesired communications. An apparatus that incorporates teachings of the present disclosure may include, for example, a communications device (100) having a transceiver (102), and a controller (112) that manages operations of the transceiver. The controller is programmed to establish (202) a communication channel with a third party, and distort (204, 206) communications on said channel upon request.

### FIELD OF THE DISCLOSURE

This disclosure relates generally to communication management techniques, and more specifically to a method and apparatus for terminating undesired communications.

### BACKGROUND

There are many instances when a person receives an undesired call on a mobile or fixed communication device. When the calling party is a close friend or family, it is undesirable to abruptly terminate the call. In any event, a polite form of terminating a call selectively (other than just hanging up on a call, which is likely to be interpreted as being rude) is currently unavailable.

### SUMMARY OF THE DISCLOSURE

Embodiments in accordance with the disclosure provide a method and apparatus for terminating undesired communications.

In a first embodiment of the present invention, a communications device has a transceiver, and a controller that manages operations of the transceiver. The controller can be programmed to establish a communication channel with a third party, and distort communications on said channel upon request.

In a second embodiment of the present invention, a computer-readable storage medium in a communication device has computer instructions for receiving a call from a third party on a communication channel, receiving a request from an end user of the communication device to apply distortion to the communication channel, and distorting communications on said channel.

In a third embodiment of the present invention, a method is provided for distorting communications with a third party on a communication channel upon request.

### BRIEF DESCRIPTION OF THE DRAWINGS

FIG. 1 is a block diagram of a communication device according to teachings of the present disclosure.

FIG. 2 is a flowchart depicting a method operating in the communication device according to teachings of the present disclosure.

FIG. 3 is a diagrammatic representation of a machine in the form of a computer system within which a set of instructions, when executed, may cause the machine to perform any one or more of the methodologies discussed herein.

### DETAILED DESCRIPTION

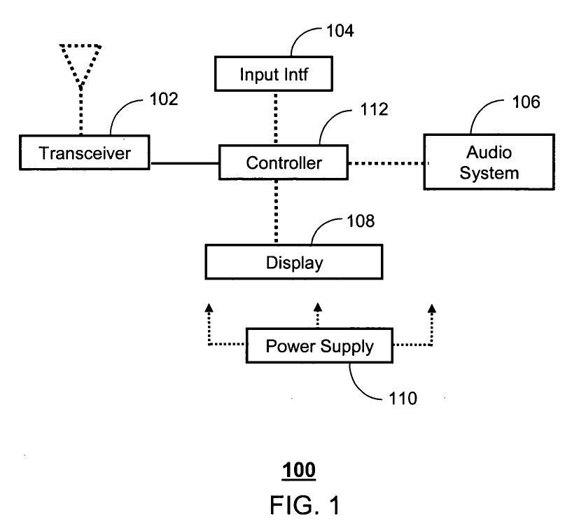

FIG. 1 is a block diagram of a communication device 100 according to teachings of the present disclosure. The communication device 100 can have a transceiver 102, an input interface 104, an audio system 106, a display 108, power supply 110, and a controller 112. The transceiver 102 can utilize wireless or wireline technology for communicating with a communication system. In the case of wireless communications, the transceiver 102 can operate in any number of communication systems that support, for example, cellular technology, WiFi, WiMax, Bluetooth, and other known and future wireless communication technologies providing end-to-end communications. In the case of wireline communications, the transceiver 102 can include technology that supports, for example, POTS (Plain Old Telephone Service), ISDN, Ethernet, and so on. Accordingly, the communication device 100 can be a portable communication device, a fixed communication device located in an enterprise or residence, or a portable multimode device that operates in any environment that provides wired or wireless access to a communication system.

The input interface 104 can be an electromechanical interface such as a keypad for selectively controlling operations of the communication device 100. The audio system 106 can utilize common technology for intercepting audio signals from a user of communication device 100 as well as for conveying audible signals thereto. The display 108 can utilize common display technology such as a liquid crystal display for conveying text and graphical images to the end user of the communication device 100. The power supply 110 can be portable or fixed. In the former embodiment, the power supply 110 can be one or more batteries integrally coupled to the components of the communication device 100 for powering said components. In the latter embodiment, the power supply 110 can be a power source supplied by a utility company, or from a central office.

The controller 112 manages operations of the aforementioned components of the communication device 100. The controller 112 can include one or more computing devices such as a microprocessor and a digital signal processor with associated volatile and non-volatile memories (e.g., Flash, RAM, DRAM, etc.). The communication device 100 as described above can provide an end user means for communicating with others by way of a communication system (not shown). Communications can be over a circuit switched network, packet switched network (such as the Internet using, for example, voice over IP communications), or combinations thereof.

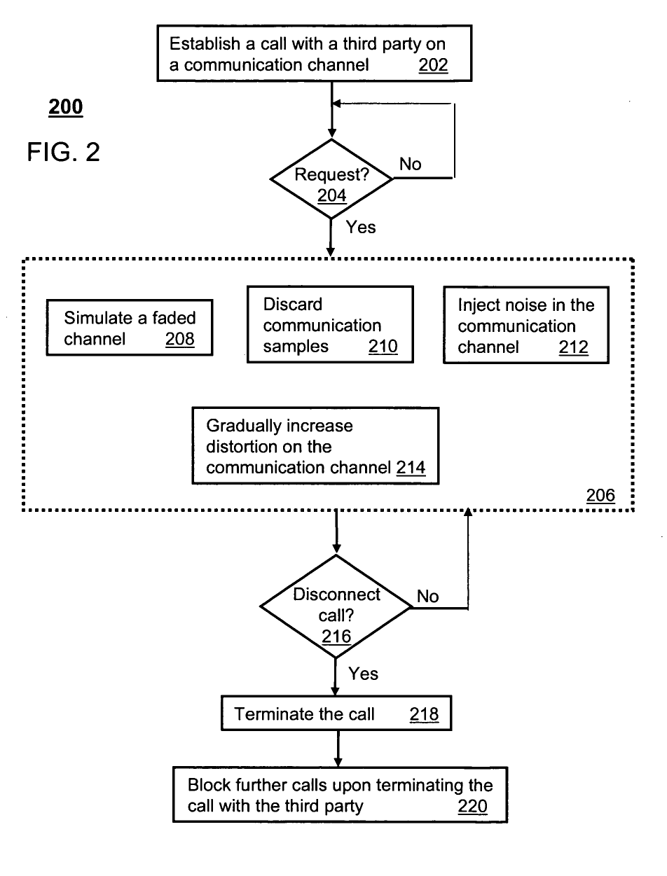

FIG. 2 is a flowchart depicting a method 200 operating in the communication device 100 according to teachings of the present disclosure. Method 200 begins with step 202 where the communication device 100 is programmed to establish a call with a third party on a communication channel of a circuit switched or packet switched communications network. This step can be a wireless or wireline communication exchange that is initiated by either the third party or the end user of the communication device. While communications are active with the third party, the communication device 100 checks in step 204 for a request to terminate the call by way of simulated distortion. If the request is detected by way of, for example, the input interface 104, the communication device 100 proceeds to step 206. Otherwise, communications continue undistorted.

In step 206, the communication device 100 can create distortion in the communication channel according to any number of embodiments some of which are illustrated in FIG. 2. For example, in step 208 the controller 112 can be programmed to simulate a faded channel. This simulation can be induced by any known means such as, for example, reducing power levels in each of the data samples by adjusting the signal-to-noise ratio (SNR) of samples transmitted to the third party. Alternatively, in step 210 the controller 112 can discard communication samples such as packets or voice samples. In yet another embodiment, the controller 112 can inject noise in step 212. Noise can be created with a pseudo-random noise generator, increasing white noise levels, adjusting SNR, injecting echo, and so on. The distortion effect created by these embodiments singly or in combination can be further enhanced by step 214 which increases the distortion gradually so as to give the effect of fading, an out of range condition, or any other form of common distortion effect.

It would be apparent to an artisan with ordinary skill in the art that the aforementioned embodiments for creating distortion are a limited set of examples taken from a vast number of techniques available today and in the future for simulating distortion in a communication system. All possible embodiments for emulating distorted communications are therefore applicable to the present disclosure without departing from the scope and spirit of the claims described below.

In step 216, the communication device 100 can be further programmed to disconnect the call from the third party according to any number of predetermined events. For example, when the distortion reaches a specific distortion level (e.g., an SNR threshold), and/or the distortion has been active for a specific period of time, the communication device 100 can be programmed to terminate the call in step 218. The call termination creates the effect and illusion for the third party of a dropped call resulting from excessive and/or prolonged distortion. To prevent calls from the third party, the communication device 100 can block calls from the third party in step 220 by, for example, entering the third party's number in a call blocking list. With the blocking list, the communication device 100 can, for example, ignore calls from parties in said list so that any calls are directed to voice mail thus making it less obvious to said parties that the end user is intentionally blocking or avoiding calls. The blocked calls can be for a limited period of time (e.g., not more than a day) for certain callers, while other callers (e.g., telemarketers) are blocked indefinitely.

Method 200 as described above provides a means for politely terminating undesired calls with third parties (whether or not they originated the call) without disclosing the means for terminating the call. Additionally, this method can be applied to portable and/or fixed communication devices (e.g., a non-portable POTS or VoIP devices) operating in any communication medium.

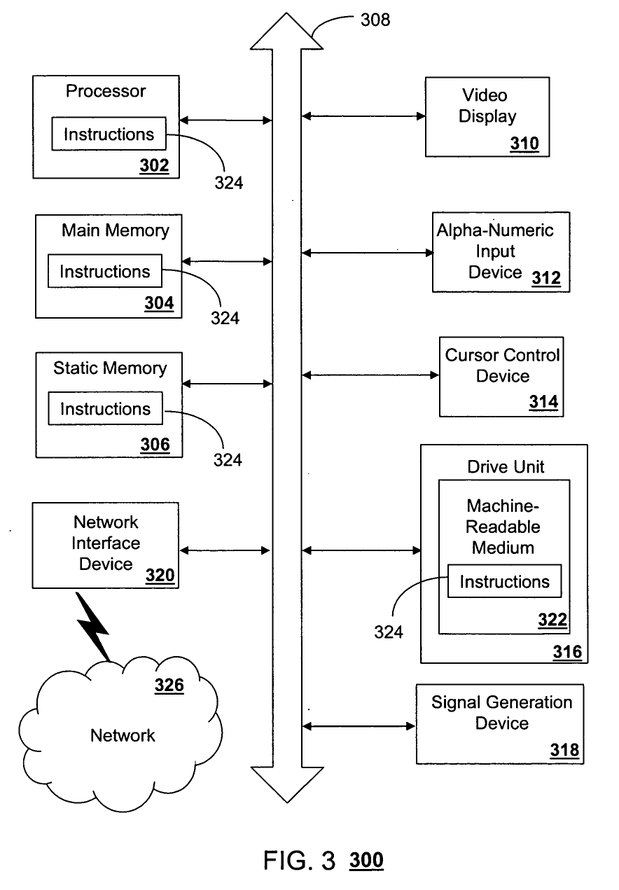

FIG. 3 is a diagrammatic representation of a machine in the form of a computer system 300 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 300 may include a processor 302 (e.g., a central processing unit (CPU), a graphics processing unit (GPU, or both), a main memory 304 and a static memory 306, which communicate with each other via a bus 308. The computer system 300 may further include a video display unit 310 (e.g., a liquid crystal display (LCD), a flat panel, a solid state display, or a cathode ray tube (CRT)). The computer system 300 may include an input device 312 (e.g., a keyboard), a cursor control device 314 (e.g., a mouse), a disk drive unit 316, a signal generation device 318 (e.g., a speaker or remote control) and a network interface device 320.

The disk drive unit 316 may include a machine-readable medium 322 on which is stored one or more sets of instructions (e.g., software 324) embodying any one or more of the methodologies or functions described herein, including those methods illustrated above. The instructions 324 may also reside, completely or at least partially, within the main memory 304, the static memory 306, and/or within the processor 302 during execution thereof by the computer system 300. The main memory 304 and the processor 302 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 324, or that which receives and executes instructions 324 from a propagated signal so that a device connected to a network environment 326 can send or receive voice, video or data, and to communicate over the network 326 using the instructions 324. The instructions 324 may further be transmitted or received over a network 326 via the network interface device 320.

While the machine-readable medium 322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A communications device, comprising:
a transceiver; and
a controller managing operations of the transceiver, and programmed to:
establish a communication channel with a third party; and
distort communications on said channel upon request.

2. The communications device of claim 1, wherein the controller is programmed to distort communications on said channel by simulating a faded channel.

3. The communications device of claim 1, wherein the controller is programmed to distort communications on said channel by discarding communication samples.

4. The communications device of claim 1, wherein the controller is programmed to distort communications on said channel by injecting noise therein.

5. The communications device of claim 1, wherein the controller is programmed to gradually increase distortion on said channel.

6. The communications device of claim 1, wherein the controller is programmed to terminate the call with the third party upon achieving one among a distortion level, and a distortion period.

7. The communications device of claim 1, wherein the controller is programmed to vary for each request the distortion technique applied to said channel.

8. The communications device of claim 1, comprising an input interface, wherein the transceiver comprises one among a wireless transceiver and a wireline transceiver, and wherein the controller is programmed to receive a request from the input interface to begin distorting communications on said channel.

9. The communications device of claim 1, wherein the controller is programmed to block calls from the third party upon termination of the call with the third party.

10. A computer-readable storage medium in a communication device, comprising computer instructions for:
establishing a call from a third party on a communication channel;
receiving a request from an end user of the communication device to apply distortion to the communication channel; and
distorting communications on said channel.

11. The storage medium of claim 10, comprising computer instructions for distorting communications on said channel by simulating a faded channel.

12. The storage medium of claim 10, comprising computer instructions for distorting communications on said channel by discarding communication samples.

13. The storage medium of claim 10, comprising computer instructions for distorting communications on said channel by injecting noise therein.

14. The storage medium of claim 10, comprising computer instructions for gradually increasing distortion on said channel.

15. The storage medium of claim 10, comprising computer instructions for terminating the call with the third party upon achieving one among a distortion level, and a distortion period.

16. The storage medium of claim 10, comprising computer instructions for varying for each request the distortion technique applied to said channel.

17. The storage medium of claim 10, comprising computer instructions for blocking calls from the third party upon termination of the call with the third party.

18. A method, comprising distorting upon request communications on a communication channel between first and second parties.

19. The method of claim 18, comprising the step of distorting communications on said channel according to at least one among a group of distortion techniques comprising simulating a faded channel, reducing power levels of samples transmitted to the third party, discarding communication samples, injecting noise in the channel, gradually increasing distortion on the channel, and terminating the call with the third party upon achieving one among a distortion level, and a distortion period.

20. The method of claim 18, comprising the steps of:
varying for each request the distortion technique applied to said channel; and
blocking further calls from the third party upon termination of the call with the third party.
